(19) United States
(12) Patent Application Publication
(10) Pub. No.: US 2024/0119721 A1
(43) Pub. Date: Apr. 11, 2024

(54) PROCESSING DATA USING CONVOLUTION AS A TRANSFORMER OPERATION

(71) Applicant: QUALCOMM Incorporated, San Diego, CA (US)

(72) Inventors: Dharma Raj KC, Tucson, AZ (US); Venkata Ravi Kiran DAYANA, San Diego, CA (US); Meng-Lin WU, San Diego, CA (US); Venkateswara Rao CHERUKURI, San Diego, CA (US)

(21) Appl. No.: 18/476,033

(22) Filed: Sep. 27, 2023

Related U.S. Application Data
(60) Provisional application No. 63/413,903, filed on Oct. 6, 2022.

(51) Int. Cl. G06V 10/82; G06V 10/77; G06V 10/80

(52) U.S. Cl. CPC G06V 10/82; G06V 10/7715; G06V 10/806

(57) ABSTRACT

Systems and techniques are described herein for processing data (e.g., image data) using convolution as a transformer (CAT) operations. The method includes receiving, at a convolution engine of a machine learning system, a first set of features, the first set of features being associated with an image and having a three-dimensional shape, applying, via the convolution engine, a depth-wise separable convolutional filter to the first set of features to generate a first output, applying, via the convolution engine, a pointwise convolutional filter to the first output to generate a second output based on global information from a spatial dimension and a channel dimension associated with the image, modifying the second output to the three-dimensional shape to generate a second set of features and combining the first set of features and the second set of features to generate an output set of features.

### PRIORITY CLAIM

The present application claims priority to Provisional Patent Application No. 63/413,903, filed Oct. 6, 2022, the contents of which are incorporated herein by reference.

### TECHNICAL FIELD

The present disclosure generally relates to processing data (e.g., image data) using convolution as a transformer (CAT) operations. In some aspects, the present disclosure is related to using a CAT engine to provide an approximation or estimation for one or more operations on the data (e.g., processing image data for object detection, object classification, object recognition, mapping operations such as simultaneous localization and mapping (SLAM), etc.). Additional or alternative aspects of the present disclosure are related to a self-attention as feature fusion (SAFF) engine for improving prediction outcomes (e.g., object detection predictions).

### BACKGROUND

Deep learning machine learning models (e.g., neural networks) can be used to perform a variety of tasks such as detection and/or recognition (e.g., scene or object detection and/or recognition), mapping (e.g., SLAM), depth estimation, pose estimation, image reconstruction, classification, three-dimensional (3D) modeling, dense regression tasks, data compression and/or decompression, image processing, among other tasks. Deep learning machine learning models can be versatile and can achieve high quality results in a variety of tasks. However, while deep learning machine learning models can be versatile and accurate, the models are often large and slow, and generally have high memory demands and computational costs. In many cases, the computational complexity of the models can be high and the models can be difficult to train.

Some deep learning machine learning models (e.g., neural networks) can include a light-weight architecture for performing image classification and/or object detection. Such light-weight models or systems include components that are used to classify or predict objects in an image (e.g., a dog as well as a tail, a head, legs or paws of the dog). In some aspects, a light-weight machine learning model can be useful when included as part of a system operating on a mobile device that does not have as much computing power or capability as other systems, such as a network server or more powerful computing system. In some cases, machine learning models (e.g., light-weight machine learning models) may utilize one or more transformers. However, a transformer can cause high latency due to the high number of calculations that are necessary for the transformer operation.

### SUMMARY

Systems and techniques are described for processing data using CAT operations, such as to perform object detection, object classification, object recognition, mapping operations (e.g., SLAM), and/or other operations on the data. In some cases, the CAT operations can be performed in a light-weight scenarios (e.g., when performing object detection using a mobile device).

In some aspects, a method is provided that includes: receiving, at a convolution engine of a machine learning system, a first set of features, the first set of features associated with an image, the first set of features being associated with a three-dimensional shape; applying, via the convolution engine, a depth-wise separable convolutional filter to the first set of features to generate a first output; applying, via the convolution engine, a pointwise convolutional filter to the first output to generate a second output based on global information from a spatial dimension and a channel dimension associated with the image; modifying the second output to the three-dimensional shape to generate a second set of features; and combining the first set of features and the second set of features to generate an output set of features.

In some aspects, an apparatus is provided that includes at least one memory and at least one processor (e.g., configured in circuitry) coupled to the at least one memory. The at least one processor is configured to: receive, at a convolution engine of a machine learning system, a first set of features associated with an image, the first set of features being associated with a three-dimensional shape; apply, via the convolution engine, a depth-wise separable convolutional filter to the first set of features to generate a first output; apply, via the convolution engine, a pointwise convolutional filter to the first output to generate a second output based on global information from a spatial dimension and a channel dimension associated with the image; and modify the second output to the three-dimensional shape to generate a second set of features and combine the first set of features and the second set of features to generate an output set of features.

In some aspects, a non-transitory computer-readable medium is provided that has stored thereon instructions that, when executed by one or more processors, cause the one or more processors to: receive, at a convolution engine of a machine learning system, a first set of features associated with an image, the first set of features being associated with a three-dimensional shape; apply, via the convolution engine, a depth-wise separable convolutional filter to the first set of features to generate a first output; apply, via the convolution engine, a pointwise convolutional filter to the first output to generate a second output based on global information from a spatial dimension and a channel dimension associated with the image; and modify the second output to the three-dimensional shape to generate a second set of features and combine the first set of features and the second set of features to generate an output set of features.

In some aspects, an apparatus is provided. The apparatus includes: means for receiving, at a convolution engine of a machine learning system, a first set of features associated with an image, the first set of features being associated with a three-dimensional shape; means for applying, via the convolution engine, a depth-wise separable convolutional filter to the first set of features to generate a first output; means for applying, via the convolution engine, a pointwise convolutional filter to the first output to generate a second output based on global information from a spatial dimension and a channel dimension associated with the image; means for modifying the second output to the three-dimensional shape to generate a second set of features; and means for combining the first set of features and the second set of features to generate an output set of features.

In some aspects, the processes described herein (e.g., process 500 and/or other process described herein) may be performed by a computing device or apparatus or a component or system (e.g., a chipset, one or more processors (e.g., CPU, GPU, NPU, DSP, etc.), ML system such as a neural network model, etc.) of the computing device or apparatus. In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of a convolutional neural network (CNN), according to aspects of the disclosure;

FIG. 2 is a diagram illustrating an example of a classification neural network system, according to aspects of the disclosure;

FIG. 3 is a diagram illustrating an example of a convolution as a transformer (CAT) engine, according to aspects of the disclosure;

FIG. 4 is a diagram illustrating an example of a self-attention as feature fusion (SAFF) engine, according to aspects of the disclosure;

FIG. 5 is a diagram illustrating an example of a method for performing object detection, according to aspects of the disclosure;

FIG. 6 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As noted previously, some deep learning machine learning models (e.g., neural networks), referred to as light-weight machine learning models (e.g., light-weight neural networks), may include less layers or components as compared to machine learning models with complex architectures. For instance, light-weight neural networks can be used for performing image classification and/or object detection. Such light-weight models or systems for deployment on mobile devices or other devices that have limited computing power or capability as other systems.

In some cases, systems with light-weight machine learning models may include the use of anchors, a backbone network, and a head (e.g., a prediction head). For instance, the light-weight system can divide an input image into multiple grids and can generate a set of anchors for each grid. An anchor can be a bounding rectangular box over one or more pixels in an image. The backbone of the system can include a convolution neural network (CNN), one or more transformers, and/or a hybrid backbone structure used to extract features from images. For example, a transformer or vision transformer can be used to divide an image into a sequence of non-overlapping patches and then learn inter-patch representations using multi-headed self-attention in transformers. The head of the light-weight system can be used to extract location-specific features from multiple output resolutions and predict offsets relative to fixed anchors. The use of heads in light-weight systems can be problematic in that there is a lack of feature aggregation from multiple scales for predictions, in which case the amount of the data available for making the prediction is limited.

A transformer is a particular type of neural network. One example of a system that uses transformers is a MobileViT system described in MobileViT: Light-weight, General-purpose, and Mobile-friendly Vision Transformer, Mehta, Rastegari, ICLR, 2022, incorporated herein by reference. Transformers perform well when used for image classification and object detection, but require a large number of calculations to perform the image classification and object detection tasks.

For instance, assuming n vectors are input to a transformer, the transformer can calculate a dot product of each vector with every other vector and then applies a Softmax layer (or in some cases a multilayer perceptron (MLP)). After the transformer applies the Softmax layer, the transformer calculates a weighted combination of the output. Transformers perform a large number of computations when perform such operations. In some cases, the large number of computations can be due to the use of pair-wise self-attention in addition to the Softmax function. Further, Softmax operations performed by the Softmax layer are known to be computationally expensive and slow. For instance, the Softmax function converts a vector of K real numbers into a probability distribution of K possible outcomes. In neural network applications, the number K of possible outcomes can be large. For instance, in the case of neural language models that predict the most likely outcome out of a vocabulary, the possible outcomes may contain millions of possible words. For prediction based on images, the outcome can even be higher. Such a large number of possible outcomes can make the calculations for the Softmax layer computationally expensive. Further, the gradient descent backpropagation method for training such a neural network involves calculating the Softmax for every training example. The number of training examples can also become large.

The use of transformers as part of the backbone structure can thus cause high latency (e.g., as compared to systems that use a CNN as a backbone) due to the high number of calculations that are necessary for the transformer operation. The latency can be particularly noticeable on mobile devices that have limited compute resources. Such computational effort is also a major limiting factor in the development of more powerful object prediction models especially on mobile devices with limited computational abilities.

Systems and techniques are described herein for improving machine learning systems (e.g., neural networks). According to some aspects, the systems and techniques provide a convolution as a transformer (CAT) engine for performing one or more operations on data (e.g., sensor data, such as image data from one or more image sensors or camera, radar data from one or more radar sensors, light detection and ranging (LIDAR) data from one or more LIDAR sensors, any combination thereof, and/or other data), such as object detection, object classification, object recognition, mapping operations (e.g., SLAM), and/or other operations on the data.

In some aspects, the CAT engine can be used in a backbone neural network architecture, such as for object classification or object detection in images. The CAT engine can utilize convolutional operations (e.g., to perform image classification, object detection, and/or operations) in a way that approximates or performs operations comparable to operations of a transformer, such as by maintaining a large, global receptive field. The CAT engine can thus improve (e.g., reduce) latency as compared to systems that use transformers. For instance, the convolutional operations can be used by the CAT engine instead of complex transformer encoder operations, such as (Q, K, V) encoding, Softmax, multilayer perceptrons (MLPs), etc. In some aspects, the use of the CAT engine can reduce the theoretical complexity of the operations from O(n²*d) or O(n*logₙ*d) to O(n*d), where “O( )” corresponds to the complexity of a function, n corresponds to the input sequence length (e.g., the number of pixels) and d is a feature vector per pixels.

Additionally or alternatively, in some aspects, the systems and techniques provide a self-attention as feature fusion (SAFF) engine that can be used in a backbone neural network architecture, such as for object classification or object detection in images. The SAFF engine can fuse features extracted from the backbone at multiple scales or abstraction levels using a transformer (e.g., using self-attention). For example, the SAFF engine can leverage transformer (Q, K, V) encodings to project features from the different scales or abstraction levels onto a common space for self-attention.

In some cases, the SAFF engine can be used in a neural network with or without the use of the CAT engine. Similarly, in some cases, the CAT engine can be used in a neural network with or without the use of the SAFF engine.

Details related to the systems and techniques are described below with respect to the figures.

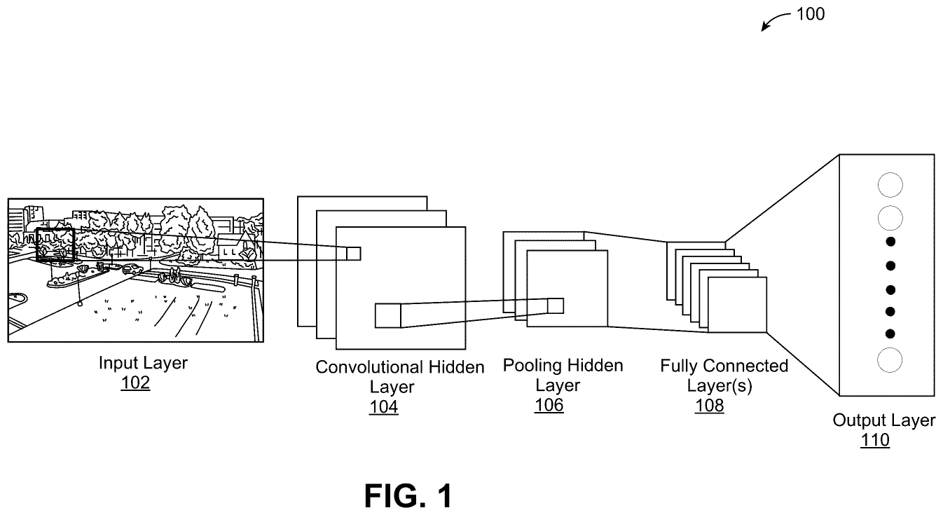

FIG. 1 is a diagram illustrating an example of a convolutional neural network (CNN) 100. The input layer 102 of the CNN 100 includes data representing an image. In some aspects, the data can include an array of numbers representing the pixels of the image, with each number in the array including a value from 0 to 255 describing the pixel intensity at that position in the array. Using the previous example from above, the array can include a 28×28×3 array of numbers with twenty-eight rows and twenty-eight columns of pixels and three color components (e.g., red, green, and blue, or luma and two chroma components, or the like). The image can be passed through a convolutional hidden layer 104, an optional non-linear activation layer, a pooling hidden layer 106, and fully connected hidden layers 108 to get an output at the output layer 110. While only one of each hidden layer is shown in FIG. 1, one of ordinary skill will appreciate that multiple convolutional hidden layers, non-linear layers, pooling hidden layers, and/or fully connected layers can be included in the CNN 100. As previously described, the output can indicate a single class of an object or can include a probability of classes that best describe the object in the image.

The first layer of the CNN 100 is the convolutional hidden layer 104. The convolutional hidden layer 104 analyzes the image data of the input layer 102. Each node of the convolutional hidden layer 104 is connected to a region of nodes (pixels) of the input image called a receptive field. The convolutional hidden layer 104 can be considered as one or more filters (each filter corresponding to a different activation or feature map), with each convolutional iteration of a filter being a node or neuron of the convolutional hidden layer 104. In some aspects, the region of the input image that a filter covers at each convolutional iteration would be the receptive field for the filter. In some cases, if the input image includes a 28×28 array, and each filter (and corresponding receptive field) is a 5×5 array, then there will be 24×24 nodes in the convolutional hidden layer 104. Each connection between a node and a receptive field for that node learns a weight and, in some cases, an overall bias such that each node learns to analyze its particular local receptive field in the input image. Each node of the hidden layer 104 will have the same weights and bias (called a shared weight and a shared bias). In some cases, the filter has an array of weights (numbers) and the same depth as the input. A filter will have a depth of three for the video frame example (according to three color components of the input image). In some aspects, a size of the filter array can be 5×5×3, corresponding to a size of the receptive field of a node.

The convolutional nature of the convolutional hidden layer 104 is due to each node of the convolutional layer being applied to its corresponding receptive field. In some aspects, a filter of the convolutional hidden layer 104 can begin in the top-left corner of the input image array and can convolve around the input image. As noted above, each convolutional iteration of the filter can be considered a node or neuron of the convolutional hidden layer 104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 104.

In some aspects, a filter can be moved by a step amount (also referred to as stride) to the next receptive field. The step amount can be set to one or other suitable amount. In some cases, if the step amount is set to one, the filter will be moved to the right by one pixel at each convolutional iteration. Processing the filter at each unique location of the input volume produces a number representing the filter results for that location, resulting in a total sum value being determined for each node of the convolutional hidden layer 104.

The mapping from the input layer to the convolutional hidden layer 104 is referred to as an activation map (or feature map). The activation map includes a value for each node representing the filter results at each location of the input volume. The activation map can include an array that includes the various total sum values resulting from each iteration of the filter on the input volume. In some aspects, the activation map can include a 24×24 array if a 5×5 filter is applied to each pixel (a step amount of one) of a 28×28 input image. The convolutional hidden layer 104 can include several activation maps in order to identify multiple features in an image. The example shown in FIG. 1 includes three activation maps. Using three activation maps, the convolutional hidden layer 104 can detect three different kinds of features, with each feature being detectable across the entire image.

In some aspects, a non-linear hidden layer can be applied after the convolutional hidden layer 104. The non-linear layer can be used to introduce non-linearity to a system that has been computing linear operations. In some aspects, a non-linear layer can be a rectified linear unit (ReLU) layer. A ReLU layer can apply the function f(x)=max(0, x) to all of the values in the input volume, which changes all the negative activations to 0. The ReLU can thus increase the non-linear properties of the CNN 100 without affecting the receptive fields of the convolutional hidden layer 104.

The pooling hidden layer 106 can be applied after the convolutional hidden layer 104 (and after the non-linear hidden layer when used). The pooling hidden layer 106 can be used to simplify the information in the output from the convolutional hidden layer 104. In some aspects, the pooling hidden layer 106 can take each activation map output from the convolutional hidden layer 104 and generate a condensed activation map (or feature map) using a pooling function. Max-pooling is one example of a function performed by a pooling hidden layer. Other forms of pooling functions be used by the pooling hidden layer 104, such as average pooling, L2-norm pooling, or other suitable pooling functions. A pooling function (e.g., a max-pooling filter, an L2-norm filter, or other suitable pooling filter) can be applied to each activation map included in the convolutional hidden layer 104. In the approach shown in FIG. 1, three pooling filters are used for the three activation maps in the convolutional hidden layer 104.

In some aspects, max-pooling can be used by applying a max-pooling filter (e.g., having a size of 2×2) with a step amount (e.g., equal to a dimension of the filter, such as a step amount of two) to an activation map output from the convolutional hidden layer 104. The output from a max-pooling filter can include the maximum number in every sub-region that the filter convolves around. Using a 2×2 filter as an example, each unit in the pooling layer can summarize a region of 2×2 nodes in the previous layer (with each node being a value in the activation map). In some aspects, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 104 having a dimension of 24×24 nodes, the output from the pooling hidden layer 106 will be an array of 12×12 nodes.

In some aspects, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. The pooling function can be performed without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 100.

The final layer of connections in the network can be a fully-connected layer that connects every node from the pooling hidden layer 106 to every one of the output nodes in the output layer 110. Using the example above, the input layer includes 28×28 nodes encoding the pixel intensities of the input image, the convolutional hidden layer 104 includes 3×24×24 hidden feature nodes based on application of a 5×5 local receptive field (for the filters) to three activation maps, and the pooling layer 106 includes a layer of 3×12×12 hidden feature nodes based on application of max-pooling filter to 2×2 regions across each of the three feature maps. As an extension of the above concept, the output layer 110 can include ten output nodes. In some aspects, every node of the 3×12×12 pooling hidden layer 106 can be connected to every node of the output layer 110.

The fully connected layer 108 can obtain the output of the previous pooling layer 106 (which should represent the activation maps of high-level features) and determines the features that most correlate to a particular class. In some aspects, the fully connected layer 108 layer can determine the high-level features that most strongly correlate to a particular class, and can include weights (nodes) for the high-level features. A product can be computed between the weights of the fully connected layer 108 and the pooling hidden layer 106 to obtain probabilities for the different classes. In some aspects, if the CNN 100 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some aspects, the output from the output layer 110 can include an M-dimensional vector (e.g., a value of the vector can be M=10), where M can include the number of classes that the program has to choose from when classifying the object in the image. Other example outputs can also be provided. Each number in the M-dimensional vector can represent the probability the object is of a certain class. In some aspects, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

One issue with backbones that use convolutional layers to extract high-level features, such as the CNN 100 in FIG. 1, is that the receptive field is limited by convolution kernel size. For instance, convolutions cannot extract global information. As noted above, transformers can be used to extract global information, but are computationally expensive and thus add significant latency in performing object classification and/or detection tasks.

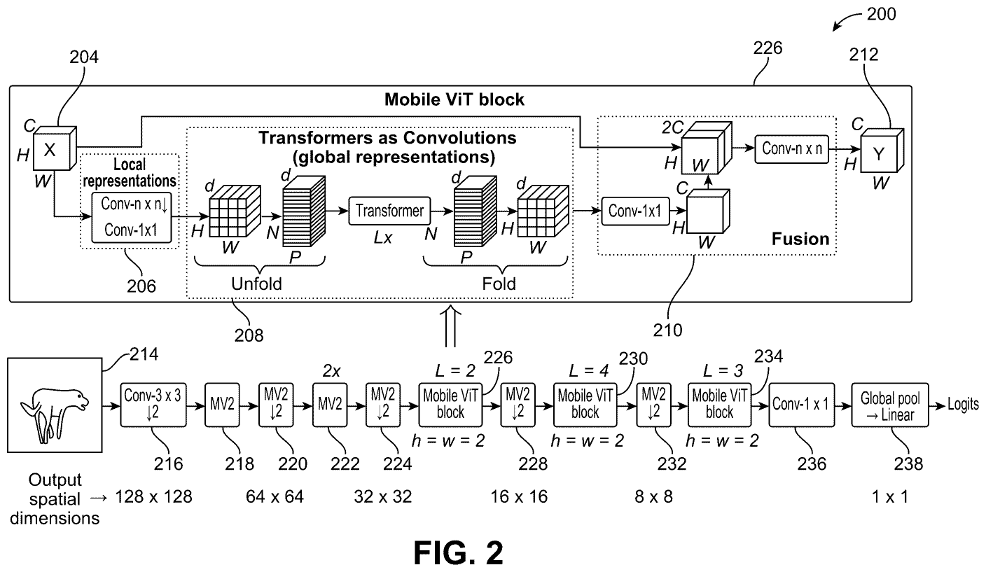

FIG. 2 illustrates a classification neural network system 200 including a mobile vision transformer (MobileViT) block 226. The MobileViT block 226 builds upon the initial application of transformers in language processing and applies that technology to image processing. Transformers for image processing measure the relationship between pairs of input tokens or pixels as the basic unit of analysis. However, computing relationships for every pixel pair in a typical image is prohibitive in terms of memory and computation. The MobileViT block 262 computes relationships among pixels in various small sections of the image (e.g., 16×16 pixels), at a drastically reduced cost. The sections (with positional embeddings) are placed in a sequence. The embeddings are learnable vectors. Each section is arranged into a linear sequence and multiplied by the embedding matrix. The result, with the position embedding, is fed to the transformer 208.

As shown in FIG. 2 and according to some aspects, an input image 214 having a height H, a width W, and a number of channels (e.g., H*W pixels with 3 channels corresponding to red, green, and blue color components) can be provided to a convolution block 216. The convolution block 216 applies a 3×3 convolutional kernel (with a step amount or stride of 2) to the input image 214. The output of the convolution block 216 is passed through a number of MobileNetv2 (MV2) blocks 218, 220, 222, 224 to generate a down-sampled output set of features 204 having a height H, a width W, and a dimension C. Each MobileNetv2 218, 220, 222, 224 is a feature extractor for extracting features from an output of a previous layer. Other feature extractors other than MobileNetv2 blocks can be used in some cases. Blocks that perform down-sampling are marked with the notation “↓2”, which corresponds to a step amount or stride of 2.

As shown in FIG. 2, the MobileViT block 226 is illustrated in more detail than other MobileViT bocks 230 and 234 of the classification neural network system 200. As shown, the MobileViT block 226 can process the set of features 204 using convolution layers to generate local representations 206. The transformers as convolutions can produce a global presentation by unfolding the data or a set of features (having a dimension of H, W, d), performing transformations using the transformer, and folding the data back up again to yield another set of features (having a dimension of H, W, d) that is then output to a fusion layer 210. The MobileViT block 226 replaces the local processing of convolutional operations with global processing (e.g., using global representations) using the transformer 208.

The fusion layer 210 can fuse the data or compare the data to the original set of features 204 to generate the output features Y 212. The output features Y 212 output from the MobileViT block 226 can be processed by the MobileNetv2 block 228, followed by another application of the MobileViT block 230, followed by another application of MobileNetv2 block 232 and yet another application of the MobileViT block 234. A 1×1 convolutional layer 236 (e.g., a fully connected layer) can then be applied to generate a global pool 238 of outputs. The downsampling of the data across the various block operations can result in taking an image size of 128×128 at block 216 and generating a 1×1 output (shown as global pool 238), which includes a global pool of linear data.

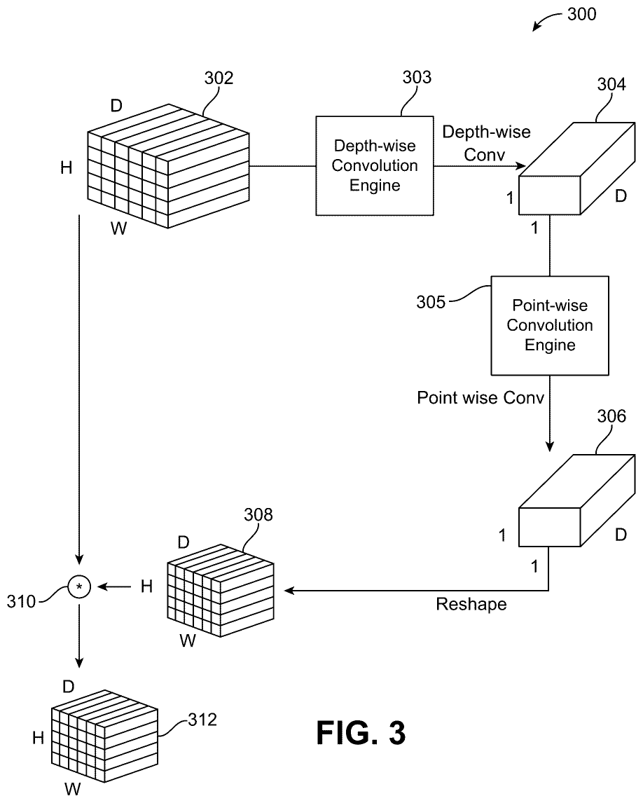

FIG. 3 is a diagram illustrating an example of a convolution as a transformer (CAT) engine 300, in accordance with aspects of the systems and techniques described herein. The CAT engine 300 can be implemented as part of a machine learning system, such as the classification neural network system 200 of FIG. 2. In some aspects, the CAT engine 300 can act or approximate the operation or result of the transformer 208 (e.g., approximating the self-attention and global feature extraction performed by the transformer 208) of the classification neural network system 200, but at much lower complexity and latency.

As shown, a set of features 302 is received at the CAT engine 300. In some aspects, the set of features 302 (also referred to as feature representations) can include the H×W×d local representations 206 of FIG. 2. In some aspects, the set of features 302 can represent any extracted feature data associated with the original image 214. The set of features 302 can represent an intermediate feature map extracted from one or more convolutions of the original image 214. The set of features 302 can include one or more of a tensor, a vector, an array, a matrix, or other data structure including values associated with the features. The set of features 302 can have a shape which can be three-dimensional, including a height H, a width W, and a dimension D. In some aspects, the set of features can relate to an image having H*W pixels, with each pixel having a color value (e.g., a Red (R) value, a Green (G) value, and a Blue (B) value) as the dimension D.

The CAT engine 300 performs a depth-wise convolution via a depth-wise convolution engine 303 to the set of features 302 to produce a first set of output features 304 which can represent global information. In some aspects, the CAT engine 300 can apply a depth-wise separable convolutional filter on the set of features 302 to produce the first set of output features 304. The set of features 302 can be referred to as an intermediate feature set (e.g., an intermediate tensor, vector, etc.). In one illustrative example, the depth-wise convolution engine 303 can be a multi-layer perceptron (MLP) operating on the spatial domain of the set of features 302.

In some aspects, the operation of the depth-wise convolution engine 303 can include where a H×W kernel can be applied to each channel in the depth dimension D of the set of features 302, with H being the height dimension and W being the width dimension. In the depth-wise convolution engine 303, the kernel size can be the same as the set of features 302. In particular, the height H and width W of the kernel can be equal to the height H and width W, respectively, of the set of features 302, resulting in a first set of output features 304 having a dimension of 1×1×D (one value (1, 1) for each channel in the depth dimension D of the set of features 302). The values in the H×W kernel can be multiplied by the feature value at each respective location in the H×W set of features 302 in each channel and the depth-wise convolution engine 303 can perform an operation to determine the value for each channel. In some aspects, the operation can include a multiply-accumulate (MAC) operation. The MAC operation can include applying the kernel to a first channel and performing an element-wise multiplication of the feature of the channel times the weights of the kernel with a summation. The depth-wise convolution engine 303 can apply the H×W kernel to each channel independently or to two or more (e.g., all in some cases) of the channels in parallel.

Typically, the image size is larger than the kernel size. Keeping the kernel size the same as the set of features 302 enables the output to be an approximation, proxy for or estimation of the global information from the spatial data (the channel locations) in the set of features 302. In some aspects, the first set of output features 304 can represent a single global vector that represents the global information extracted from the spatial domain of the set of features 302.

The first set of output features 304 can be provided to a point-wise convolution engine 305. The point-wise convolution engine 305 can apply a pointwise convolutional filter to the first set of output features 304 and extract global information from the channel dimension D. In some aspects, the combination of the depth-wise convolution engine 303 and the point-wise convolution engine 305 can be referred to as a convolution engine. The point-wise convolution engine 305 can apply a kernel having a kernel size of 1×1×D (e.g., the kernel size can have a depth equal to the depth D—referring to the number of channels—of the set of features 302), which can be a fully connected layer. The convolution engine 305 can iterate the 1×1 kernel through each point or value of the first set of output features 304, processing the values in all channels in the dimension D of the first set of output features 304. In some aspects, the first set of output features 304 can be considered a 1×D input vector and the matrix associated with the point-wise convolution can be a D×D matrix. A 1×D input vector or matrix times a D×D matrix results in a second output of a 1×D vector or matrix. The point-wise convolution engine 305 can extract information into a single value by processing all the channels of the first set of output features 304 and returning a single value. The point-wise convolution engine 305 therefore can extract information from the channel dimension D to generate a set of features 306, which can be considered as global information such as a global vector. The set of features 306 can then be modified (e.g., by duplicating the value in each dimension D of the set of features 306 in the H and W dimensions) to yield another set of features 308 having a dimension of H×W×D. The set of features 308 can be considered global information that has a same three-dimensional shape as the set of features 302 and that approximates or estimates global information in both the spatial domain and the channel dimension. One approach to achieve the modifying by duplicating the respective value in each dimension D of the set of features 306 is as follows:

y=reshape(global_information,(H,W,D)).

Using such a formulation, the CAT engine 300 can distribute the values of vector in the H and W dimensions. The set of features 308 can be characterized as an output vector that represents an approximation or estimation of the global information from both the spatial and the channel dimension. The CAT engine 300 can then perform an element-wise product 310 between the set of features 308 (the global information) and the set of features 302 to generate an output set of features 312 (e.g., as an output feature map). In some cases, the element-wise product 310 can be performed as follows:

x=elementwise_product(x,y).

The element-wise product 310 determines how the local vectors in the set of features 302 correlate to the global information in the set of features 306 or the set of features 308 and thus extracts how each local vector in the set of features 302 correlates with the set of features 306 or 308 (e.g., which can be global information, such as a global vector, as noted previously). If two respective comparative values are similar, then the values will be relatively larger. If two respective comparative values are dissimilar, then values will be relatively larger but in the negative direction. Such a characteristic of the CAT engine 300 allows the CAT engine 300 to mimic the operations of a transformer 208 of FIG. 2. In the transformer 208, the approach is to take the dot-product between each respective pixel with every other pixel, which is computationally expensive. Instead of that process, the CAT engine 300 uses the global information in the set of features 308 as an approximation and rather than implementing a dot-product, the CAT engine 300 uses an element-wise product 310 between the global information in the set of features 308 and the set of features 302. The output set of features 312 represents the set of features identifying the correlation between the set of features 302 and the global information or set of features 308.

In such cases, the CAT engine 300 can be applied iteratively (two or more times). In such cases, a first convolution engine (which can include the depth-wise convolution engine 303 and the point-wise convolution engine 305) can process an input feature map to generate an intermediate feature map. A second convolution engine (e.g., the depth-wise convolution engine 303, the point-wise convolution engine 305) can process the intermediate feature map to generate an output feature map. Additional convolution engines (e.g., the depth-wise convolution engine 303, the point-wise convolution engine 305) can be applied as well.

A benefit of using the CAT engine 300 is to address the high latency due to the self-attention layers and use of the Softmax function by the transformer 208. By using the CAT engine 300, the latency may be reduced by over 50% relative to the use of the transformer 208. The use of simpler functions than the self-attentive layers in the transformer 208 provides the lower latency and a lower number of computations and thus the tradeoff can be useful for mobile device object prediction. Thus, the approach disclosed above provides an improvement in performance of devices performing object classification or detection. In some aspects, the complexity is reduced from O(n²*d) to O(n*d). In one aspect, the approach is to use convolution operations instead of the complex transformer encoder operations such as (Q, K, V) encoding, Softmax functions and multilayer perceptrons (MLPs).

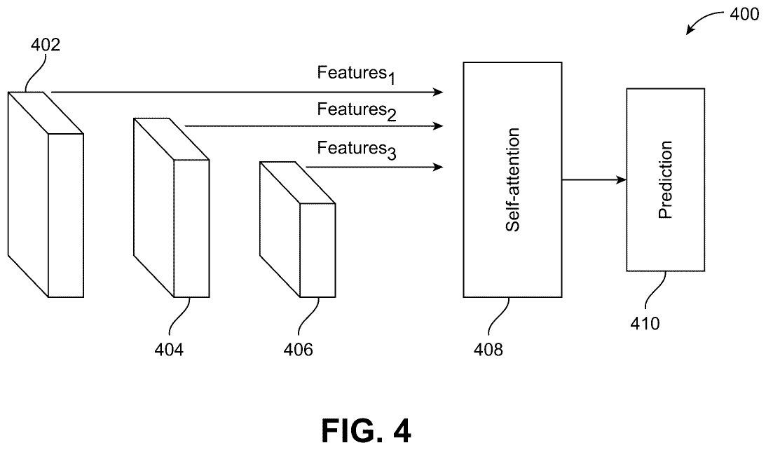

FIG. 4 illustrates an example of a self-attention as a feature fusion (SAFF) engine 400. The SAFF engine 400 can be implemented as part of a machine learning system, such as the classification neural network system 200 of FIG. 2, an object detection system, or other system. The SAFF engine 400 can extracts features from multiple resolution intermediate feature maps 402, 404, 406 and can use a self-attention layer 408 (also referred to as a self-attention engine) to fuse the feature maps which can be used for prediction. Visual self-attention is a mechanism of relating different positions of a single sequence to compute a representation of the same sequence. The SAFF engine 400 allows a neural network to focus on specific parts of a complicated input one by one (intermediate feature maps 402, 404, etc., in the disclosed example) until the entire dataset can be categorized.

The SAFF engine 400 or self-attention layer 408 aggregates features from multiple different resolutions or scales from the different intermediate feature maps 402, 404, 406 and increases the accuracy of the ultimate prediction. Each feature map from the intermediate feature maps 402, 404, 406 includes a set of features output by a convolutional layer of the underlying neural network (e.g., the backbone), with later feature maps having a lower dimension of data from the original image 214. The different size of the feature map results from different convolutional operations being performed on the input image 214 and feature map output by subsequent blocks in FIG. 2. In some aspects, the image 214 is downsampled at block 216 to a size of 128×128, the output features of which are downsampled at block 218 to a size of 64×64, the output features of which are downsampled at block 224 to 32×32, and so forth. Each of the differently-sized feature maps as they are downsampled can correspond to the intermediate feature maps 402, 404, 406 in FIG. 4, which can be referred to as intermediate feature maps 402, 404, 406.

Each intermediate feature map 402, 404, 406 is detected at a certain resolution that is related to the anchor or box rectangles discussed above. The use of the three intermediate feature maps 402, 404, 406 is by way of example only. Any number of two or more feature maps may be used in connection with the concept of the SAFF engine 400.

An input image in a typical system is received at a backbone of a neural network system. The backbone can be the, such as the classification neural network system 200 if FIG. 2, which can in some cases include the CAT engine 300 of FIG. 3 in place of the transformer 208 shown in FIG. 2. Features are extracted from multiple layers. In some aspects, some of the layers of the backbone, or new layers that are added, are used to extract features from different resolutions.

The SAFF engine 400 can make a prediction for each resolution or for each intermediate feature map. In some aspects, in the traditional approach, one intermediate feature map 402 may have a resolution of 19×19 values or pixels so the system would perform 19×19 predictions from that layer. The 19×19 values can relate to using 19×19 anchor boxes as discussed above. Another intermediate feature map 404 may have a resolution of 10×10 values so the system would perform 10×10 predictions. The intermediate feature map 406 may have a resolution of 3×3 values so the system would perform 3×3 predictions. The SAFF engine 400 looks at the different feature maps and predicts the object in the image. The traditional approach described above is a single-shot multi-box detector (SSD) architecture.

The improvement disclosed in FIG. 4 involves extracting features from multiple resolution intermediate feature maps 402, 404, 406 and providing that data to the self-attention layer 408 that will fuse the feature maps which can be used for prediction by a prediction layer 410.

Each intermediate feature map 402, 404, 406 can represent a respective successive output of a convolutional filter (or other approaches). Each respective intermediate feature map 402, 404, 406 can have a reduced size from the original image 214 or from a previous input to a respective convolutional filter. Each intermediate feature map 402, 404, 406 can represent a different output and/or can be associated with performing detection at a particular resolution related to anchor boxes that are applied. Thus, if the intermediate feature map 402 has a 19×19 dimension, then the intermediate feature map 402 relates to 19×19 anchor boxes. If the system predicts from intermediate layers or maps 402, 404, 406, then a particular lower-level layer or intermediate feature map 402 may be used to detect a tail of a dog for example and another intermediate feature map 404 may be used to detect the head of the dog. If intermediate feature map 406 has a dimension of 1×1, then the intermediate feature map 406 may be used for predicting with only one anchor box an object in the entire image. In other words, if a picture of dog covers the entire image 214, then the dog might be predicted from the 1×1 dimensional intermediate map 406. The feature map 406 can be a single vector that has all the information associated with the original image which might be, in some aspects, 300×300 pixels. A 3×3 intermediate feature map (in one aspect, feature map 404) could try to predict nine objects within the image 214. Each intermediate feature map 402, 404, 406 can be used to predict objects at a particular scale.

A method or process of providing the self-attention as feature fusion via the SAFF engine 400 can include obtaining first features from an intermediate feature map having a first resolution (e.g., intermediate feature map 402) and extracting second features from an intermediate feature map having a second resolution (e.g., intermediate feature map 404). Based on the first features and the second features (e.g., the features in the respective intermediate feature maps 402 and 404), the SAFF engine 400 can fuse, via a self-attention layer 408, the first features and the second features to yield fused features. The method or process can include predicting (using a prediction layer 410) an element in the image based on the fused features.

In some cases, the self-attention layer 408 can perform a dot-product of each feature of the first features of the first resolution intermediate feature map 402 with each other feature in the second resolution intermediate feature map 404 to generate the first features, performs a dot-product of each feature of the second features of the second resolution intermediate feature map with each other feature in the first resolution intermediate feature map 402 to generate the second features. The SAFF engine 400 (e.g., the self-attention layer 408) can apply a Softmax function to the first features and the second features and can perform a weighted summation across the first features and the second features to fuse the first features and the second features from multiple resolutions for prediction by the prediction layer 410.

In some aspects, if there are more than two feature maps (FIG. 4 shows three intermediate feature maps 402, 404, 406), then for each pixel in intermediate feature map 402, the self-attention layer 408 can apply self-attention for that respective pixel in feature map 402 to every other pixel in the intermediate feature map 402 plus to every other pixel of one or more other feature maps 404, 406. The result will be to obtain useful information for that pixel in one intermediate feature map 402 from those other feature maps 404, 406 and calculate a new feature vector based on the combined data. Thus, while previously the feature sets for each feature map would be features₁, features₂, and features₃ for each of the intermediate feature maps 402, 404, 406, the SAFF engine 400 can generate a new value of features_{1′}, features_{2′}, and features_{3′}. Each of the features_{1′}, features_{2′}, and features_{3′} can be used to make a separate prediction, and the SAFF engine 400 can fuse information from other layers to return a better prediction based on features_{1′}, features_{2′}, and features_{3′}. The features features_{1′}, features_{2′}, and features_{3′} are more robust than features₁, features₂, and features₃. For example, smaller feature maps, such as feature map 406, can have a view or information associated with other intermediate feature maps 402, 404, making the predictive capability of the SAFF engine 400 more robust. The SAFF engine 400 introduces a more global view of the data by applying information from other feature maps to make a prediction on any individual pixel in any of the intermediate feature maps 402, 404, 406.

The Softmax function converts a vector of K real numbers into a probability distribution of K possible outcomes. The Softmax function can be used as a last activation function of a neural network to normalize the output of a network to a probability distribution over predicted output classes. In some aspects, prior to applying the Softmax function, some vector components could be negative, or greater than one; and might not sum to 1. After applying the Softmax function, each component will be in the interval, and the components will add up to 1, so that they can be interpreted as probabilities. Functions other than the formal Softmax could be applied as well that perform the conversion of the real numbers into a probability distribution.

The method can further include performing a first prediction occurs based on the first features, performing a second prediction based on the second features and performing a third prediction based on the fused features. While the approach above only included two intermediate feature maps such as maps 402, 404, the method can cover three intermediate maps including map 406 or more intermediate feature maps as well.

In general, the SAFF engine 400 and the use of the self-attention layer 408, rather than doing separate predictions, fuses the predictions from two or more of the multiple scales, resolutions or intermediate feature maps 402, 404, 406. The SAFF engine 400 (and/or the prediction layer 410) still makes three predictions but the SAFF engine 400 fuses, via the self-attention layer 408, the information from neighboring intermediate feature maps 402, 404, 406 to make the final prediction more intelligence by using the fused information.

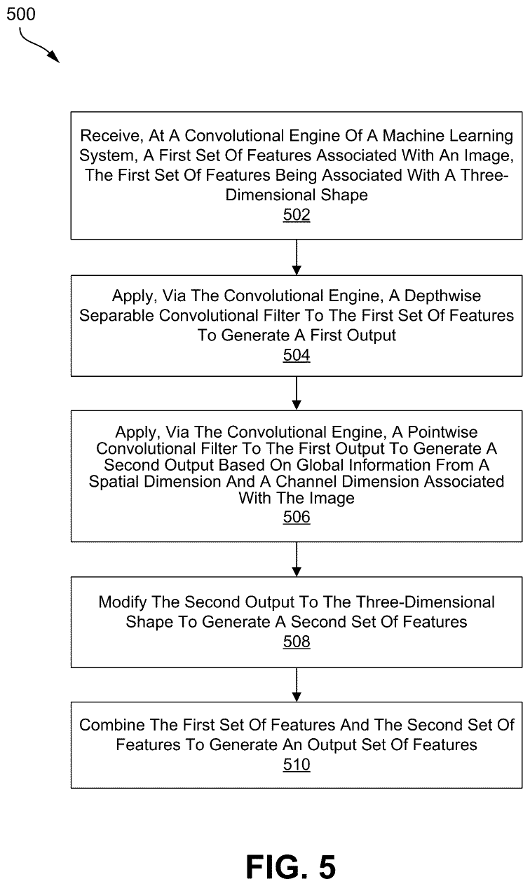

FIG. 5 illustrates an example of a process 500 for processing image data, such as using a CAT engine (e.g., as described with respect to FIG. 3) and/or a SAFF engine 400 (e.g., as described with respect to FIG. 4). At block 502, the process 500 can include receiving, at a convolution engine of a machine learning system, a first set of features. In some aspects, the first set of features can be associated with an image (or other data). In some examples, the first set of features can be associated with a three-dimensional shape. In some cases, the first set of features can include a first tensor, a first vector, a first matrix, a first array, and/or other representation including values for the first set of features.

At block 504, the method can include applying, via a convolution engine of a machine learning system, a depth-wise separable convolutional filter to the first set of features to generate a first output. In some aspects, the convolution engine can include the CAT engine 300 of FIG. 3. For instance, the depth-wise convolution engine 303 of the CAT engine 300 can apply the depth-wise separable convolutional filter to the first set of features, as described herein. The convolution engine can be configured to perform transformer operations (e.g., the convolution engine approximate operations of a transformer 208). Additionally or alternatively, in some aspects, the convolution engine can be configured to perform pair-wise self-attention and global feature extraction operations (e.g., the convolution engine approximates a pair-wise self-attention model and global feature extraction for image classification). In some aspects, the depth-wise separable convolutional filter applied by the convolution engine (e.g., the depth-wise convolution engine 303) can include a spatial multilayer perceptron (MLP), a fully-connected layer, or other layer that extracts information from a spatial domain of the first set of features to generate the first output.

At block 506, the process 500 can include applying, via the convolution engine (e.g., the CAT engine 300), a pointwise convolutional filter to the first output to generate a second output based on (or that approximates) global information from a spatial dimension and a channel dimension associated with the image. For instance, the point-wise convolution engine 305 of the CAT engine 300 can apply the pointwise convolutional filter to the first output to generate the second output, as described herein. In some aspects, the pointwise convolutional filter applied by the convolution engine (e.g., the pointwise convolution engine 305) can include a channel multilayer perceptron (MLP) that extracts information from a channel dimension of the first set of features to generate the second output.

At block 508, the process 500 can include modifying the second output to the three-dimensional shape to generate a second set of features. In some cases, the first set of features can be associated with a local representation of the image and the second set of features can be associated with a global representation of the image. In some cases, the second set of features can include a second tensor, a second vector, a second matrix, a second array, and/or other representation including values for the second set of features.

At block 510, the process 500 can include combining the first set of features and the second set of features to generate an output set of features. In some aspects, the output set of features can include an output tensor, an output vector, an output matrix, an output array, and/or other representation including values for the output set of features. In some cases, the process 500 can include performing, via the machine learning system, image classification associated with the image (e.g., to classify one or more objects in the image) based on the output set of features. In some cases, the process 500 can include performing, via the machine learning system, object detection (e.g., to determine a location and/or pose of one or more objects in the image and, in some cases, generate a respective bounding box for each object of the one or more objects) associated with the image based on the output set of features. In some cases, combining the first set of features and the second set of features to generate the output set of features can include performing an element-wise product 310 between the first set of features 302 and the set of features 308, as described with respect to FIG. 3.

In some aspects, the process 500 can further include receiving, at a second convolution engine of the machine learning system (e.g., an additional CAT engine of the machine learning system), a third set of features. The third set of features can be generated based on the output set of features. The process 500 can further include, applying, via the second convolution engine, an additional depth-wise separable convolutional filter to the third set of features to generate a third output. The process 500 can include applying, via the second convolution engine, an additional pointwise convolutional filter to the third output to generate a fourth output based on the global information from the spatial dimension and the channel dimension associated with the image. The process 500 can further include modifying the fourth output to the three-dimensional shape to generate a fourth set of features. The process 500 can include combining the third set of features and the fourth set of features to generate an additional output set of features.

In some cases, the process 500 can apply principles from the SAFF engine 400, independently or in conjunction with the principles of the CAT engine described above. For instance, the process 500 can include obtaining first features from a first intermediate feature map based on the output set of features. The first intermediate feature map can have a first resolution. The process 500 can further include obtaining second features from a second intermediate feature map based on the output set of features. The second intermediate feature map can have a second resolution that is different from the first resolution. The process 500 can include combining, via a self-attention engine (e.g., the SAFF engine 400), the first features and the second features to generate fused features and predicting via a prediction layer (e.g., prediction layer 410) a location of an object in the image based on the fused features. In some aspects, the first intermediate feature map may include the intermediate feature map 402 of FIG. 4 and the second intermediate feature map may include the intermediate feature map 404.

In some cases, to combine the first features and the second features, the process 500 can include performing, via the self-attention engine (e.g., the SAFF engine 400), a first dot-product of each feature of the first features of the first intermediate feature map with each feature of the second features in the second intermediate feature map 404. The process 500 can include performing, via the self-attention layer 408, a second dot-product of each feature of the second features of the second intermediate feature map with each feature of the first features in the first intermediate feature map. The process 500 can further include applying, via the self-attention layer 408, a Softmax function to an output of the first dot-product and an output of the second dot-product. The process 500 can include performing, via the self-attention layer 408, a weighted summation of an output of the Softmax function to combine the first features and the second features.

The process 500 can further include performing a first prediction, via a prediction layer (e.g., prediction layer 410), based on the first features and performing a second prediction, via the prediction layer, based on the second features. The process 500 can include performing a third prediction, via the prediction layer 410, based on the fused features. While the above approach includes a reference to two intermediate feature maps, more than two intermediate feature maps may be processed in a similar manner using the SAFF engine 400.

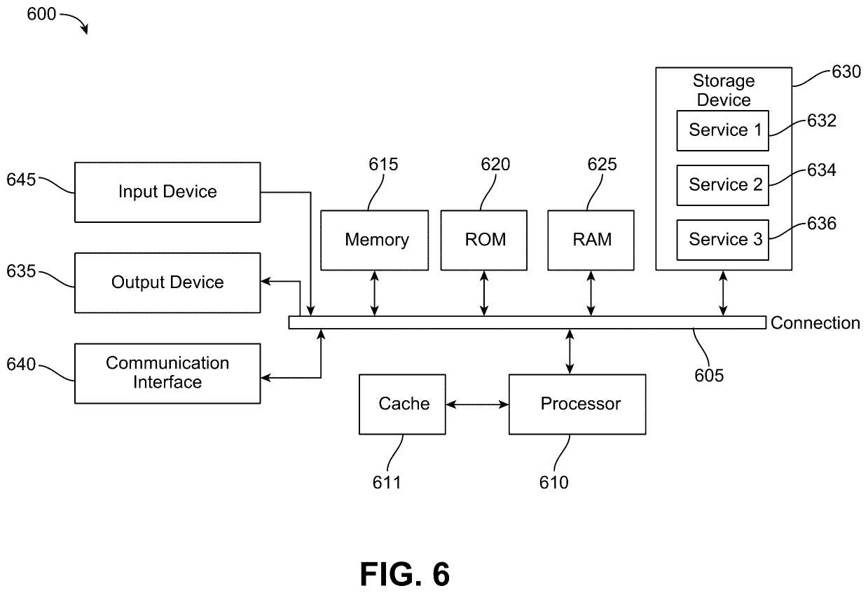

In some aspects, the processes described herein (e.g., process 500 and/or other process described herein) may be performed by a computing device or apparatus or a component or system (e.g., a chipset, one or more processors (e.g., central processing unit (CPU), graphics processing unit (GPU), neural processing unit (NPU), digital signal processor (DSP), etc.), ML system such as a neural network model, etc.) of the computing device or apparatus. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the computing system 600 of FIG. 6, a vehicle, and/or other computing device or apparatus.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 500 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some aspects, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. In some aspects, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The process 500 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500, method and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 is a diagram illustrating a system for implementing certain aspects of the present technology. In particular, FIG. 6 illustrates a computing system 600, which can be any computing device making up internal computing system, a remote computing system, a camera, or any component thereof in which the components of the system are in communication with each other using connection 605. Connection 605 can be a physical connection using a bus, or a direct connection into processor 610, such as in a chipset architecture. Connection 605 can also be a virtual connection, networked connection, or logical connection.

In some aspects, computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

The system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache 611 of high-speed memory connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms. In some instances, multimodal systems can enable a user to provide multiple types of input/output to communicate with computing system 600. Computing system 600 can include communications interface 640, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 640 may also include one or more GNSS receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, the code causes the system to perform a function. In some aspects, a hardware service that performs a particular function can include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. In some aspects, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, in some aspects, instructions and data which cause or otherwise configure a general-purpose computer, special purpose computer, or a processing device to perform a certain function or group of functions. Portions of computer resources used can be accessible over a network. The computer executable instructions may be, in some aspects, binaries, intermediate format instructions such as assembly language, firmware, source code. Examples of computer-readable media that may be used to store instructions, information used, and/or information created during methods according to described approaches include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, according to some aspects.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, in some aspects, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. In some aspects, claim language reciting “at least one of A and B” or “at least one of A or B” means A, B, or A and B. In some aspects, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. In some aspects, claim language reciting “at least one of A and B” or “at least one of A or B” can mean A, B, or A and B, and can additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate the interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, then the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A processor-implemented method of processing image data, the method comprising: receiving, at a convolution engine of a machine learning system, a first set of features associated with an image, the first set of features being associated with a three-dimensional shape; applying, via the convolution engine, a depth-wise separable convolutional filter to the first set of features to generate a first output; applying, via the convolution engine, a pointwise convolutional filter to the first output to generate a second output based on global information from a spatial dimension and a channel dimension associated with the image; modifying the second output to the three-dimensional shape to generate a second set of features; and combining the first set of features and the second set of features to generate an output set of features.

Aspect 2. The processor-implemented method of Aspect 1, wherein the convolution engine is configured to perform transformer operations.

Aspect 3. The processor-implemented method of Aspect 1 or Aspect 2, wherein the convolution engine is configured to perform pair-wise self-attention and global feature extraction operations.

Aspect 4. The processor-implemented method of any previous Aspect, further comprising performing, via the machine learning system, image classification associated with the image based on the output set of features.

Aspect 5. The processor-implemented method of any previous Aspect, further comprising: receiving, at a second convolution engine of the machine learning system, a third set of features, the third set of features being generated based on the output set of features; applying, via the second convolution engine, an additional depth-wise separable convolutional filter to the third set of features to generate a third output; applying, via the second convolution engine, an additional pointwise convolutional filter to the third output to generate a fourth output based on the global information from the spatial dimension and the channel dimension associated with the image; modifying the fourth output to the three-dimensional shape to generate a fourth set of features; and combining the third set of features and the fourth set of features to generate an additional output set of features.

Aspect 6. The processor-implemented method of any previous Aspect, wherein the first set of features is associated with a local representation of the image and the second set of features is associated with a global representation of the image.

Aspect 7. The processor-implemented method of any previous Aspect, wherein the depth-wise separable convolutional filter comprises a spatial multilayer perceptron that extracts information from a spatial domain of the first set of features to generate the first output.

Aspect 8. The processor-implemented method of any previous Aspect, wherein the pointwise convolutional filter comprises a channel multilayer perceptron that extracts information from a channel dimension of the first set of features to generate the second output.

Aspect 9. The processor-implemented method of any previous Aspect, wherein combining the first set of features and the second set of features to generate the output set of features comprises performing an element-wise cross-product between the first set of features and the second set of features.

Aspect 10. The processor-implemented method of any previous Aspect, wherein the first set of features comprises a first tensor, wherein the second set of features comprises a second tensor, and wherein the output set of features comprises an output tensor.

Aspect 11. The processor-implemented method of any previous Aspect, further comprising: obtaining first features from a first intermediate feature map based on the output set of features, the first intermediate feature map having a first resolution; obtaining second features from a second intermediate feature map based on the output set of features the second intermediate feature map having a second resolution different from the first resolution; combining, via a self-attention engine, the first features and the second features to generate fused features; and predicting a location of an object in the image based on the fused features.

Aspect 12. The processor-implemented method of any previous Aspect, wherein combining the first features and the second features comprises: performing, via the self-attention engine, a first dot-product of each feature of the first features of the first intermediate feature map with each feature of the second features in the second intermediate feature map; performing, via the self-attention engine, a second dot-product of each feature of the second features of the second intermediate feature map with each feature of the first features in the first intermediate feature map; applying, via the self-attention engine, a Softmax function to an output of the first dot-product and an output of the second dot-product; and performing, via the self-attention engine, a weighted summation of an output of the Softmax function to combine the first features and the second features.

Aspect 13. The processor-implemented method of any previous Aspect, further comprising performing a first prediction based on the first features; performing a second prediction based on the second features; and performing a third prediction based on the fused features.

Aspect 14. An apparatus for processing image data, comprising: at least one memory; and at least one processor coupled to at least one memory and configured to: receive, at a convolution engine of a machine learning system, a first set of features associated with an image, the first set of features being associated with a three-dimensional shape; apply, via the convolution engine, a depth-wise separable convolutional filter to the first set of features to generate a first output; apply, via the convolution engine, a pointwise convolutional filter to the first output to generate a second output based on global information from a spatial dimension and a channel dimension associated with the image; modify the second output to the three-dimensional shape to generate a second set of features; and combine the first set of features and the second set of features to generate an output set of features.

Aspect 15. The apparatus of Aspect 14, wherein the convolution engine is configured to perform transformer operations.

Aspect 16. The apparatus of Aspect 15, wherein the convolution engine is configured to perform pair-wise self-attention and global feature extraction operations.

Aspect 17. The apparatus of Aspect 15, wherein the at least one processor coupled to at least one memory is further configured to: perform, via the machine learning system, image classification associated with the image based on the output set of features.

Aspect 18. The apparatus of Aspect 15, wherein the at least one processor coupled to at least one memory is further configured to: receiving, at a second convolution engine of the machine learning system, a third set of features, the third set of features being generated based on the output set of features; applying, via the second convolution engine, an additional depth-wise separable convolutional filter to the third set of features to generate a third output; applying, via the second convolution engine, an additional pointwise convolutional filter to the third output to generate a fourth output based on the global information from the spatial dimension and the channel dimension associated with the image; modifying the fourth output to the three-dimensional shape to generate a fourth set of features; and combining the third set of features and the fourth set of features to generate an additional output set of features.

Aspect 19. The apparatus of any of Aspects 14-18, wherein the first set of features is associated with a local representation of the image and the second set of features is associated with a global representation of the image.

Aspect 20. The apparatus of any of Aspects 14-19, wherein the depth-wise separable convolutional filter comprises a spatial multilayer perceptron that extracts information from a spatial domain of the first set of features to generate the first output.

Aspect 21. The apparatus of claim 1 any of Aspects 14-20, wherein the pointwise convolutional filter comprises a channel multilayer perceptron that extracts information from a channel dimension of the first set of features to generate the second output.

Aspect 22. The apparatus of any of Aspects 14-21, wherein combining the first set of features and the second set of features to generate the output set of features comprises performing an element-wise cross-product between the first set of features and the second set of features.

Aspect 23. The apparatus of any of Aspects 14-22, wherein the first set of features comprises a first tensor, wherein the second set of features comprises a second tensor, and wherein the output set of features comprises an output tensor.

Aspect 24. The apparatus of any of Aspects 14-23, wherein the at least one processor coupled to at least one memory is further configured to: obtain first features from a first intermediate feature map based on the output set of features, the first intermediate feature map having a first resolution; obtain second features from a second intermediate feature map based on the output set of features the second intermediate feature map having a second resolution different from the first resolution; combine, via a self-attention engine, the first features and the second features to generate fused features; and predict a location of an object in the image based on the fused features.

Aspect 25. The apparatus of any of Aspects 14-24, wherein the at least one processor coupled to at least one memory is further configured to combine the first features and the second features by: performing, via the self-attention engine, a first dot-product of each feature of the first features of the first intermediate feature map with each feature of the second features in the second intermediate feature map; performing, via the self-attention engine, a second dot-product of each feature of the second features of the second intermediate feature map with each feature of the first features in the first intermediate feature map; applying, via the self-attention engine, a Softmax function or similar function to an output of the first dot-product and an output of the second dot-product; and performing, via the self-attention engine, a weighted summation of an output of the Softmax function or the similar function to combine the first features and the second features.

Aspect 26. The apparatus of any of Aspects 14-25, wherein the at least one processor coupled to at least one memory is further configured to: perform a first prediction based on the first features; perform a second prediction based on the second features; and perform a third prediction based on the fused features.

Aspect 27. A non-transitory computer-readable medium having stored thereon instructions that, when executed by one or more processors, cause the one or more processors to perform operations according to any of Aspect 1 to 26.

Aspect 28. An apparatus for processing image data, the apparatus including one or more means for performing operations according to any of Aspect 1 to 26.

What is claimed is:

1. A processor-implemented method of processing image data, the method comprising:
receiving, at a convolution engine of a machine learning system, a first set of features associated with an image, the first set of features being associated with a three-dimensional shape;
applying, via the convolution engine, a depth-wise separable convolutional filter to the first set of features to generate a first output;
applying, via the convolution engine, a pointwise convolutional filter to the first output to generate a second output based on global information from a spatial dimension and a channel dimension associated with the image;
modifying the second output to the three-dimensional shape to generate a second set of features; and
combining the first set of features and the second set of features to generate an output set of features.

2. The processor-implemented method of claim 1, wherein the convolution engine is configured to perform transformer operations.

3. The processor-implemented method of claim 1, wherein the convolution engine is configured to perform pair-wise self-attention and global feature extraction operations.

4. The processor-implemented method of claim 1, further comprising:
performing, via the machine learning system, image classification associated with the image based on the output set of features.

5. The processor-implemented method of claim 1, further comprising:
receiving, at a second convolution engine of the machine learning system, a third set of features, the third set of features being generated based on the output set of features;
applying, via the second convolution engine, an additional depth-wise separable convolutional filter to the third set of features to generate a third output;
applying, via the second convolution engine, an additional pointwise convolutional filter to the third output to generate a fourth output based on the global information from the spatial dimension and the channel dimension associated with the image;
modifying the fourth output to the three-dimensional shape to generate a fourth set of features; and
combining the third set of features and the fourth set of features to generate an additional output set of features.

6. The processor-implemented method of claim 1, wherein the first set of features is associated with a local representation of the image and the second set of features is associated with a global representation of the image.

7. The processor-implemented method of claim 1, wherein the depth-wise separable convolutional filter comprises a spatial multilayer perceptron that extracts information from a spatial domain of the first set of features to generate the first output.

8. The processor-implemented method of claim 1, wherein the pointwise convolutional filter comprises a channel multilayer perceptron that extracts information from a channel dimension of the first set of features to generate the second output.

9. The processor-implemented method of claim 1, wherein combining the first set of features and the second set of features to generate the output set of features comprises performing an element-wise cross-product between the first set of features and the second set of features.

10. The processor-implemented method of claim 1, wherein the first set of features comprises a first tensor, wherein the second set of features comprises a second tensor, and wherein the output set of features comprises an output tensor.

11. The processor-implemented method of claim 1, further comprising:
obtaining first features from a first intermediate feature map based on the output set of features, the first intermediate feature map having a first resolution;
obtaining second features from a second intermediate feature map based on the output set of features the second intermediate feature map having a second resolution different from the first resolution;
combining, via a self-attention engine, the first features and the second features to generate fused features; and
predicting a location of an object in the image based on the fused features.

12. The processor-implemented method of claim 11, wherein combining the first features and the second features comprises:
performing, via the self-attention engine, a first dot-product of each feature of the first features of the first intermediate feature map with each feature of the second features in the second intermediate feature map;
performing, via the self-attention engine, a second dot-product of each feature of the second features of the second intermediate feature map with each feature of the first features in the first intermediate feature map;
applying, via the self-attention engine, a Softmax function to an output of the first dot-product and an output of the second dot-product; and
performing, via the self-attention engine, a weighted summation of an output of the Softmax function to combine the first features and the second features.

13. The processor-implemented method of claim 11, further comprising:
performing a first prediction based on the first features;
performing a second prediction based on the second features; and
performing a third prediction based on the fused features.

14. An apparatus for processing image data, comprising:
at least one memory; and
at least one processor coupled to at least one memory and configured to:
receive, at a convolution engine of a machine learning system, a first set of features, the first set of features being associated with an image and having a three-dimensional shape;
apply, via the convolution engine, a depth-wise separable convolutional filter to the first set of features to generate a first output;
apply, via the convolution engine, a pointwise convolutional filter to the first output to generate a second output based on global information from a spatial dimension and a channel dimension associated with the image;
modify the second output to the three-dimensional shape to generate a second set of features; and
combine the first set of features and the second set of features to generate an output set of features.

15. The apparatus of claim 14, wherein the convolution engine is configured to perform transformer operations.

16. The apparatus of claim 14, wherein the convolution engine is configured to perform pair-wise self-attention and global feature extraction operations.

17. The apparatus of claim 14, wherein the at least one processor is further configured to:
perform, via the machine learning system, image classification associated with the image based on the output set of features.

18. The apparatus of claim 14, wherein the at least one processor is further configured to:
receive, at a second convolution engine of the machine learning system, a third set of features, the third set of features being generated based on the output set of features;
apply, via the second convolution engine, an additional depth-wise separable convolutional filter to the third set of features to generate a third output;
apply, via the second convolution engine, an additional pointwise convolutional filter to the third output to generate a fourth output based on the global information from the spatial dimension and the channel dimension associated with the image;
modify the fourth output to the three-dimensional shape to generate a fourth set of features; and
combine the third set of features and the fourth set of features to generate an additional output set of features.

19. The apparatus of claim 14, wherein the first set of features is associated with a local representation of the image and the second set of features is associated with a global representation of the image.

20. The apparatus of claim 14, wherein the depth-wise separable convolutional filter comprises a spatial multilayer perceptron that extracts information from a spatial domain of the first set of features to generate the first output.

21. The apparatus of claim 14, wherein the pointwise convolutional filter comprises a channel multilayer perceptron that extracts information from a channel dimension of the first set of features to generate the second output.

22. The apparatus of claim 14, wherein combining the first set of features and the second set of features to generate the output set of features comprises performing an element-wise cross-product between the first set of features and the second set of features.

23. The apparatus of claim 14, wherein the first set of features comprises a first tensor, wherein the second set of features comprises a second tensor, and wherein the output set of features comprises an output tensor.

24. The apparatus of claim 14, wherein the at least one processor is further configured to:
obtain first features from a first intermediate feature map based on the output set of features, the first intermediate feature map having a first resolution;
obtain second features from a second intermediate feature map based on the output set of features the second intermediate feature map having a second resolution different from the first resolution;
combine, via a self-attention engine, the first features and the second features to generate fused features; and
predict a location of an object in the image based on the fused features.

25. The apparatus of claim 24, wherein, to combine the first features and the second features, the at least one processor is further configured to:
perform, via the self-attention engine, a first dot-product of each feature of the first features of the first intermediate feature map with each feature of the second features in the second intermediate feature map;
perform, via the self-attention engine, a second dot-product of each feature of the second features of the second intermediate feature map with each feature of the first features in the first intermediate feature map;
apply, via the self-attention engine, a Softmax function to an output of the first dot-product and an output of the second dot-product; and
perform, via the self-attention engine, a weighted summation of an output of the Softmax function to combine the first features and the second features.

26. The apparatus of claim 24, wherein the at least one processor coupled is further configured to:
perform a first prediction based on the first features;
perform a second prediction based on the second features; and
perform a third prediction based on the fused features.

27. A non-transitory computer-readable memory storing instructions which cause at least one processor coupled to the non-transitory computer-readable memory to be configured to:
receive, at a convolution engine of a machine learning system, a first set of features, the first set of features being associated with an image and having a three-dimensional shape;
apply, via the convolution engine, a depth-wise separable convolutional filter to the first set of features to generate a first output;
apply, via the convolution engine, a pointwise convolutional filter to the first output to generate a second output based on global information from a spatial dimension and a channel dimension associated with the image;
modify the second output to the three-dimensional shape to generate a second set of features; and
combine the first set of features and the second set of features to generate an output set of features.

28. The non-transitory computer-readable memory of claim 27, wherein the convolution engine is configured to perform transformer operations.
